(19) United States
(12) Patent Application Publication
(10) Pub. No.: US 2011/0308249 A1
(43) Pub. Date: Dec. 22, 2011

(54) SOLAR THERMAL SYSTEMS

(76) Inventors: Eli Mandelberg, Tel Aviv (IL); Oren Michael Gadot, Nes-Ziona (IL); Hagay Cafri, Bet-Hashmonay (IL); Yotam Zohar, Haifa (IL)

(21) Appl. No.: 13/148,674

(22) PCT Filed: Feb. 15, 2010
(86) PCT No.: PCT/IL2010/000134

§ 371 Date: Aug. 10, 2011

Related U.S. Application Data
(60) Provisional application No. 61/152,718, filed on Feb. 15, 2009.
(60) Provisional application No. 61/167,153, filed on Apr. 7, 2009.
(60) Provisional application No. 61/175,048, filed on May 3, 2009.

(51) Int. Cl. F03G 6/06; F24J 2/10; F24J 2/30; F24J 2/04

(52) U.S. Cl. 60/641.15; 126/634; 126/684; 126/636; 126/643

(57) ABSTRACT

A solar thermal system comprising at least one solar system including a solar system working fluid flowing therethrough, and a solar receiver for heating the solar system working fluid by solar radiation admitted into the solar receiver, and a thermal energy system in fluid communication with the solar system and receiving the heated solar system working fluid so as to produce thermal energy.

### REFERENCE TO CO-PENDING APPLICATIONS

Applicant hereby claims priority of U.S. provisional application No. 61/152,718 filed on Feb. 15, 2009, entitled “Solar Cycle Systems”; U.S. provisional application No. 61/167,153, filed on Apr. 7, 2009, entitled “Solar Cycle Systems” and U.S. provisional application No. 61/175,048, filed on May 3, 2009, entitled “Solar Cycle Systems” all which are incorporated herein by reference in their entirety.

### FIELD OF THE INVENTION

The present invention relates generally to solar thermal systems.

### BACKGROUND OF THE INVENTION

Thermal energy systems that generate thermal energy by combustion of fossil fuels are well known. These thermal energy systems provide heat to thermal energy consumption systems in the form of hot gas, such as air, or heated vapor, typically steam. Additionally the heated vapor may be expanded within a vapor turbine for generation of electricity therefrom.

### SUMMARY OF THE INVENTION

There is thus provided in accordance with an embodiment of the present invention a solar thermal system comprising at least one solar system including a solar system working fluid flowing therethrough, and a solar receiver for heating the solar system working fluid by solar radiation admitted into the solar receiver, and a thermal energy system in fluid communication with the solar system and receiving the heated solar system working fluid so as to produce thermal energy. Accordingly, the solar radiation is concentrated by a dish configured to concentrate the solar radiation prior to being admitted into the solar receiver. Additionally, the solar system working fluid is selected from the group consisting of air, water, helium, molten salt, an organic fluid, oil, and carbon dioxide.

In accordance with an embodiment of the present invention the thermal energy is used for vaporization, pasteurization, drying, drying polymer containing products, providing vapor to vapor consuming systems, direct heating of a solid desiccant system or absorption cooling. Additionally, the thermal energy system includes a vapor turbine for generating electrical energy. Furthermore, the thermal energy is used for boosting a vapor turbine. Moreover, the thermal energy is used for boosting a steam turbine included in a combined cycle gas fired system.

In accordance with another embodiment of the present invention the solar system is an open loop system or a closed loop system. Additionally, the thermal energy system is an open loop system or a closed loop system. Accordingly, the solar thermal system is configured to introduce the solar system working fluid into at least one heat exchanger. Furthermore, the thermal energy system includes a vapor generation cycle. Moreover, the thermal energy system includes a vapor turbine with a plurality of inlets for flow of vapor therein.

In accordance with yet another embodiment of the present invention the solar system includes a turbine for generation of electricity. Additionally, the solar system includes a gas turbine for generation of electricity. Accordingly, the solar system includes a compressor configured to compress the solar system working fluid prior to entering the solar receiver. Furthermore, a combustor is provided intermediate the solar receiver and the gas turbine. Moreover, the solar thermal system includes a thermal storage assembly configured to selectively store at least some of heated solar system working fluid.

In accordance with still another embodiment of the present invention the thermal energy system is in fluid communication with the solar system via a heat exchanger. Additionally, a heat transfer fluid is heated in the heat exchanger by the solar system working fluid, the heated heat transfer fluid is provided to heat a vapor generation cycle fluid of a vapor generation cycle. Accordingly, the heat transfer fluid is air.

There is thus provided in accordance with another embodiment of the present invention a solar thermal system comprising at least one solar system including a solar system working fluid flowing therethrough, and a solar receiver for heating the solar system working fluid by solar radiation admitted into the solar receiver, and a thermal energy system in fluid communication with the solar system, the thermal energy system is for providing thermal energy produced via the heated solar system working fluid.

There is thus provided in accordance with yet another embodiment of the present invention a thermal energy consuming system operative to consume thermal energy produced by a thermal energy system in fluid communication with at least one solar system, the solar system includes a solar system working fluid flowing therethrough, and a solar receiver for heating the solar system working fluid by solar radiation admitted into the solar receiver, the solar system working fluid being received by the thermal energy system thereby producing the thermal energy.

### BRIEF DESCRIPTION OF THE DRAWING

The present subject matter will be understood and appreciated more fully from the following detailed description, taken in conjunction with the drawings in which:

FIGS. 1A and 1B are each a simplified schematic illustration of a solar thermal system, constructed and operative in accordance with an embodiment of the present invention;

FIGS. 2A and 2B are each a simplified schematic illustration of a solar thermal system, constructed and operative in accordance with another embodiment of the present invention;

FIGS. 3A and 3B are each a simplified schematic illustration of a solar thermal system, constructed and operative in accordance with yet another embodiment of the present invention;

FIGS. 4A and 4B are each a simplified schematic illustration of a solar thermal system, constructed and operative in accordance with still another embodiment of the present invention;

FIGS. 5A and 5B are each a simplified schematic illustration of a solar thermal system, constructed and operative in accordance with a further embodiment of the present invention;

FIGS. 6A and 6B are each a simplified schematic illustration of a solar thermal system, constructed and operative in accordance with yet a further embodiment of the present invention;

FIGS. 7A and 7B are each a simplified schematic illustration of a solar thermal system, constructed and operative in accordance with still a further embodiment of the present invention;

FIGS. 8A and 8B are each a simplified schematic illustration of a solar thermal system, constructed and operative in accordance with another embodiment of the present invention; and

FIGS. 9A and 9B are each a simplified schematic illustration of a solar thermal system, constructed and operative in accordance with yet another embodiment of the present invention.

### DETAILED DESCRIPTION OF EMBODIMENTS

In the following description, various aspects of the present subject matter will be described. For purposes of explanation, specific configurations and details are set forth in order to provide a thorough understanding of the present subject matter. However, it will also be apparent to one skilled in the art that the present subject matter may be practiced without specific details presented herein without departing from the scope of the present invention. Furthermore, the description omits and/or simplifies some well known features in order not to obscure the description of the subject matter.

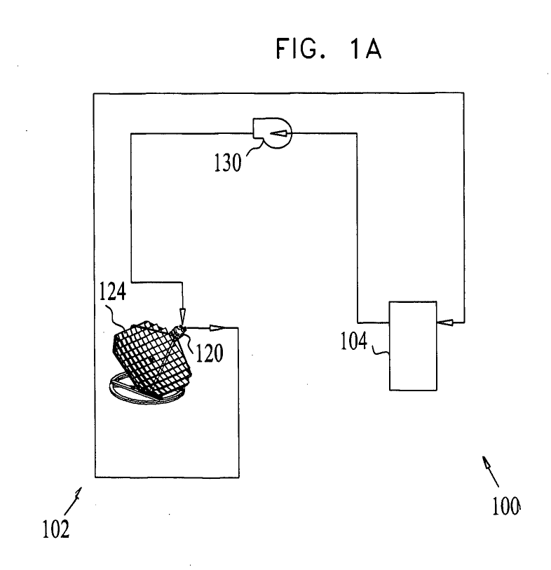

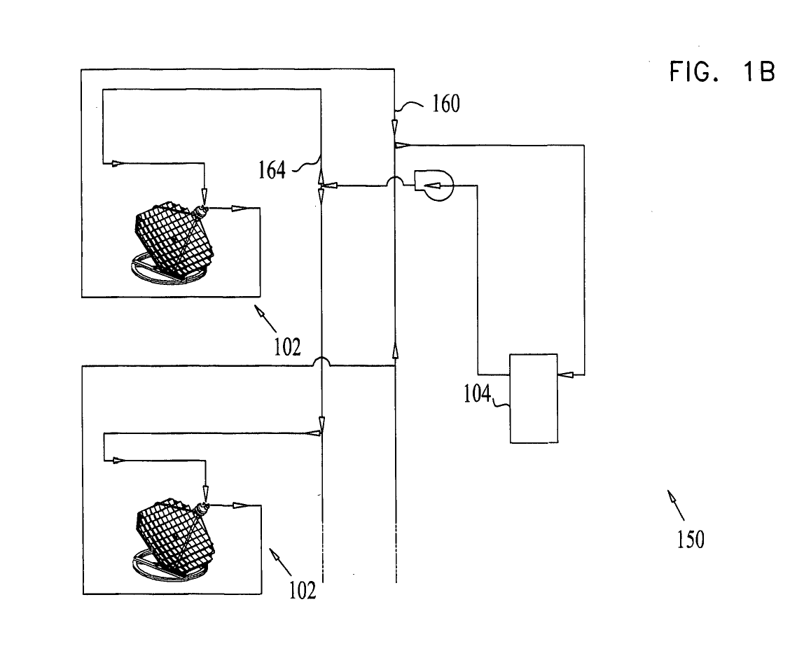

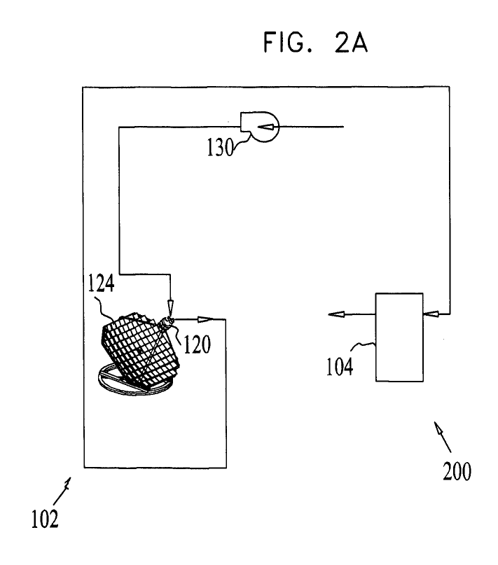

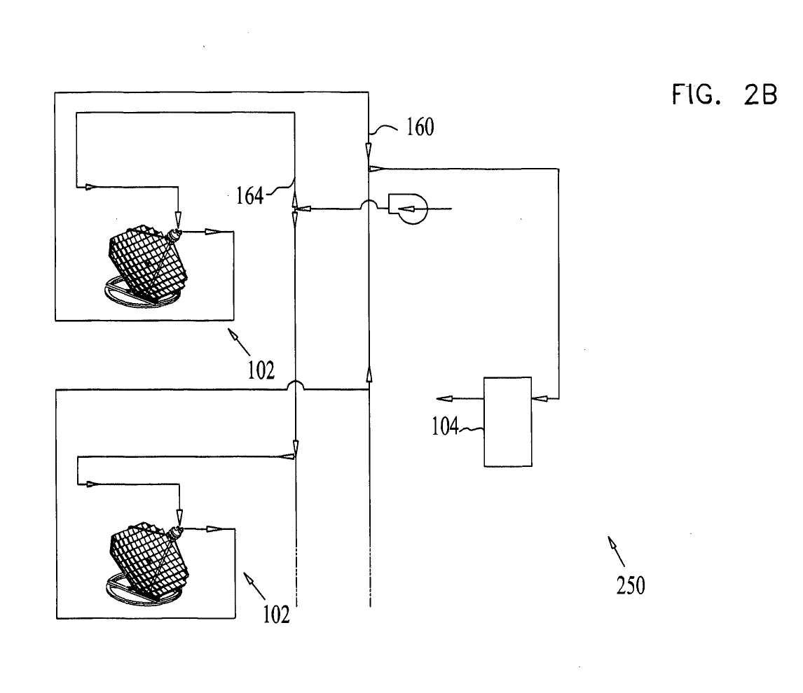

Reference is now made to FIGS. 1A-2B, which are a simplified schematic illustration of a solar thermal system, constructed and operative in accordance with an embodiment of the present invention. As seen in FIG. 1A, a solar thermal system 100 comprises a solar system 102 and a thermal energy system 104. The solar system 102 generally comprises a receiver 120 operative to heat a working fluid therein. Any suitable working fluid, such as air, water, helium, molten salt, oil, any organic fluid, or carbon dioxide, for example, may flow within the solar system 102 and/or the thermal energy system 104, for operation thereof.

Solar receiver 120 may be any suitable solar receiver designated to heat the working fluid by concentrated solar radiation admitted therein. The solar radiation may be concentrated by any suitable solar collection system. The solar collection system may comprise any suitable means for concentrating solar radiation, for example using a sun-tracking concentrator, such as a dish, a trough, a Fresnel reflector, or a heliostat. In the examples shown in FIGS. 1A-9B the sun-tracking concentrator is a dish 124.

The solar system 102 communicates with thermal energy system 104. Thermal energy system 104 may receive thermal energy from any number of solar systems 102. For example, several hundred solar systems 102 may supply thermal energy to a single thermal energy system 104 or a plurality of thermal energy systems 104, as will be further described in reference to FIG. 1B hereinbelow.

In the embodiment shown in FIG. 1A, the solar thermal system 100 comprises a closed loop cycle, though it is appreciated that an open loop cycle may be utilized, as illustrated in FIG. 2A.

A working fluid enters the receiver 120 and is heated therein. The heated working fluid exits the receiver 120 and flows to thermal energy system 104. The working fluid may thereafter be re-introduced into receiver 120 so as to be re-heated thereby and to thereafter further provide thermal energy in the form of heat to the thermal energy system 104. A blower 130 may be provided to ensure the working fluid continues to flow between receiver 120 and thermal energy system 104.

It is noted that wherein the working fluid is a gas, such as air, a blower may be provided, and wherein the working fluid is a liquid, such as water, a pump may be provided to ensure continuous flow of the working fluid. It is further noted that additional blowers and/or pumps may be added to the solar system 102 and/or the thermal energy system 104 to ensure that the working fluid flows continuously.

The thermal energy system 104 is designated to provide thermal energy for any thermal energy consuming system. In a non-limiting example, thermal energy system 104 may provide thermal energy for industrial systems, such as for the food industry. Moreover, the thermal energy may be utilized for vaporization, pasteurization or any other heat consuming processes used in the chemical industry or other industries. The thermal energy may be used for drying, such as drying polymer containing products, for example. The thermal energy may be introduced into a vapor turbine for generation of electricity therefrom. Additionally, the thermal energy may be provided to boost a vapor turbine, typically a steam turbine, such as a coal or gas fuel fired steam turbine or a steam turbine comprised in a combined cycle gas fired system. Furthermore, the thermal energy may be provided to provide vapor or systems consuming vapor, such as steam. The thermal energy may also be utilized for direct heating of a solid desiccant system, such as a desiccant system comprised in an air conditioning system. The thermal energy may be used for absorption cooling such as by steam or heated air, for example.

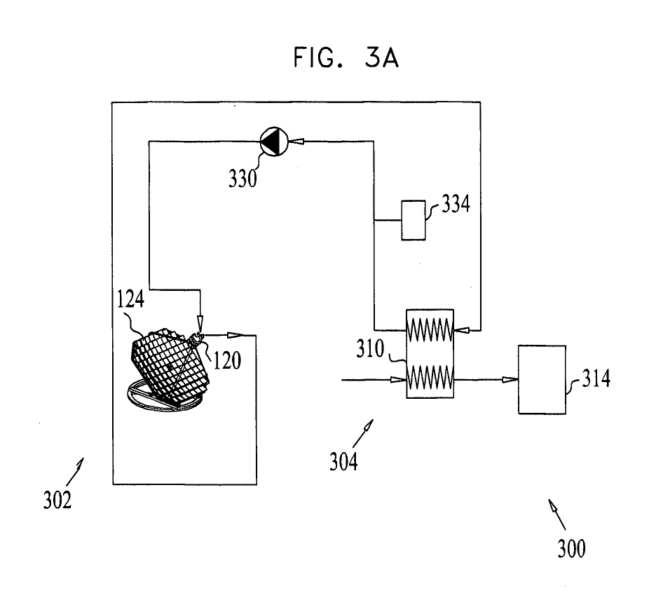

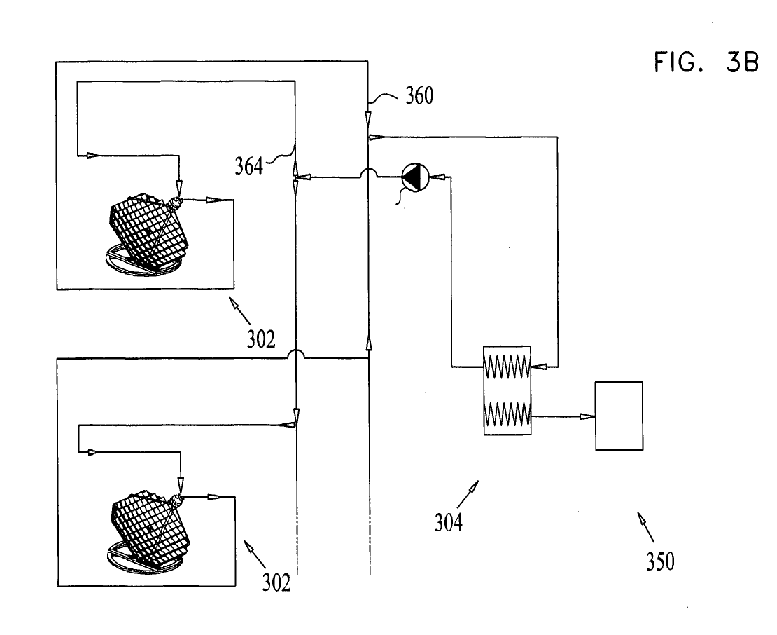

Furthermore, heat exchangers (not shown) may be provided to transfer the thermal energy from the solar system 102 on to other thermal systems, as will be shown in FIGS. 3A and 3B.

In a non-limiting example the working fluid is air which enters the receiver 120 at a temperature of approximately 100° C. and a pressure of approximately 1.2 bar.

The temperature of the working fluid exiting receiver 120 is approximately 600° C. and the pressure is 1.18 bar.

It is appreciated that the exiting working fluid temperature from receiver 120 may be selected according to the specific properties of the thermal energy consuming system.

As seen in FIG. 1B, a solar thermal system 150 may comprise a plurality of solar systems 102. Although only two solar systems are illustrated, it will be appreciated that any number of solar systems may be provided, typically from ten to several hundred. Each of the plurality of solar systems 102 is in thermal communication with the thermal energy system 104 via a first main duct 160, provided to transfer the working fluid from each of the plurality of solar systems 102 to thermal energy system 104. A second main duct 164 is provided to transfer the working fluid from thermal energy system 104 to each of the plurality of solar systems 102.

Components of the solar thermal systems 100 and 150, such as the solar receiver 120 and blower 130, may be connected therebetween by a plurality of any suitable conduits.

Turning to FIGS. 2A and 2B, respective solar thermal systems 200 and 250 are shown. Solar thermal system 200 is similar to solar thermal system 100 of FIG. 1A wherein solar thermal system 100 is a closed loop system and solar thermal system 200 is an open loop system. Solar thermal system 250 is similar to solar thermal system 150 of FIG. 1B wherein solar thermal system 150 is a closed loop system and solar thermal system 250 is an open loop system.

In a non-limiting example the incoming working fluid is air and flows to receiver 120 at ambient temperature and pressure. The working fluid exiting receiver 120 is approximately 600° C. and the pressure is approximately 1.07 bar. The working fluid exits thermal energy system 104 to the ambient at a temperature of approximately 90° C. and at ambient pressure.

Reference is now made to FIGS. 3A and 3B, which are a simplified schematic illustration of a solar thermal system, constructed and operative in accordance with yet another embodiment of the present invention. As seen in FIG. 3A, a solar thermal system 300 comprises a solar system 302 and a thermal energy system 304.

The solar system 302 communicates with thermal energy system 304. Thermal energy system 304 may receive thermal energy from any number of solar systems 302. For example, several hundred solar systems 302 may supply thermal energy to a single thermal energy system 304 or a plurality of thermal energy systems 304, as will be further described in reference to FIG. 3B hereinbelow.

In the embodiment shown in FIG. 3A, the solar thermal system 300 comprises a closed loop cycle, though it is appreciated that an open loop cycle may be utilized.

A working fluid enters the receiver 120 and is heated therein. The heated working fluid exits the receiver 120 and flows to a heat exchanger 310 of thermal energy system 304. The working fluid may thereafter be re-introduced into receiver 120 so as to be re-heated thereby and to thereafter further provide thermal energy in the form of heat to the thermal energy system 104. A pump 330 may be provided to ensure the working fluid continues to flow between receiver 120 and thermal energy system 304. Additionally, an expansion vessel 334 may be provided to enable expansion of the working fluid prior to entering the receiver 120 wherein the working fluid temperature is elevated. Alternatively, the expansion vessel 334 may be obviated.

The heat exchanger 310 is operative to transfer thermal energy in the form of heat to a thermal energy consuming system 314 via a fluid entering heat exchanger 310 from the ambient. The fluid is heated with the heat exchanger 310 and flows to thermal energy consuming system 314. Thermal energy consuming system 314 is designated to provide thermal energy for any thermal energy consuming system, as described hereinabove with reference to thermal energy system 104 of FIGS. 1A and 1B.

In a non-limiting example the working fluid is molten salt which enters the receiver 120 at a temperature of approximately 220° C. and a pressure of approximately 4.5 bar. The temperature of the working fluid exiting receiver 120 is approximately 600° C. and the pressure is approximately 4 bar. The fluid entering the heat exchanger 310 is air at a temperature of approximately 80° C. and a pressure of approximately 4 bar. The fluid is heated within heat exchanger 310 and enters the consumption system 314 at a temperature of approximately 600° C. and pressure of approximately 3.8 bar.

As seen in FIG. 3B, a solar thermal system 350 may comprise a plurality of solar systems 302. Although only two solar systems are illustrated, it will be appreciated that any number of solar systems may be provided, typically from ten to several hundred. Each of the plurality of solar systems 302 is in thermal communication with the thermal energy system 304 via a first main duct 360, provided to transfer the working fluid from each of the plurality of solar systems 302 to thermal energy system 304. A second main duct 364 is provided to transfer the working fluid from thermal energy system 304 to each of the plurality of solar systems 302.

Components of the solar thermal systems 300 and 350, such as the solar receiver 120 and pump 330, may be connected therebetween by a plurality of any suitable conduits.

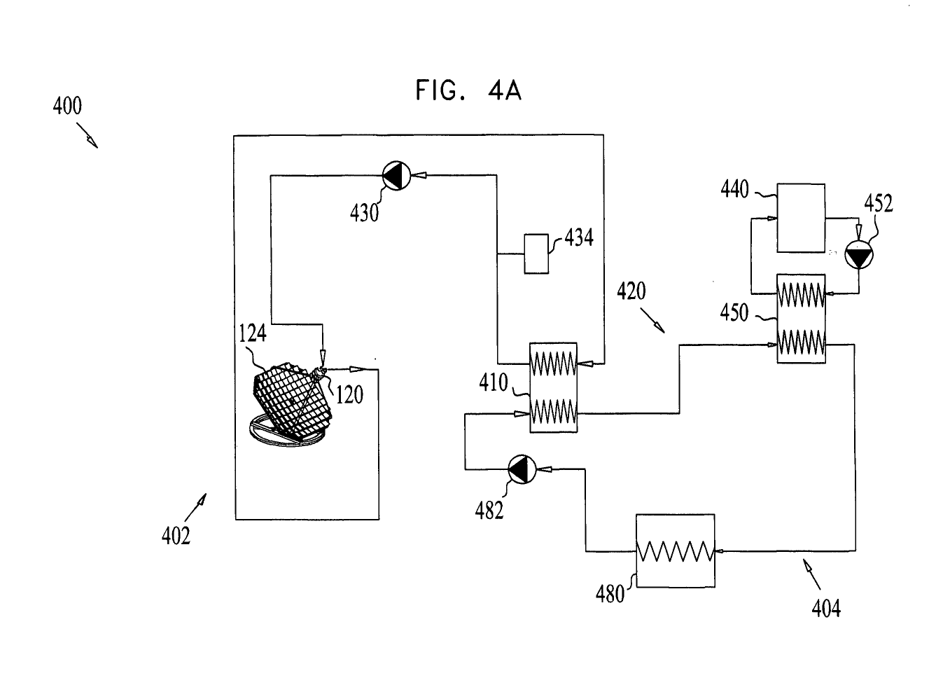

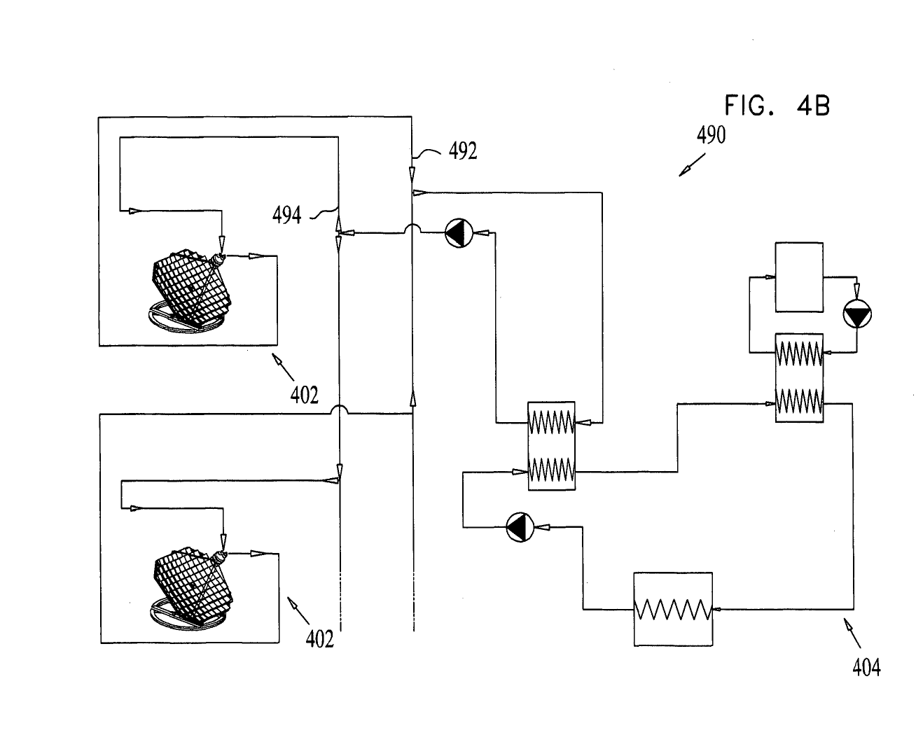

Reference is now made to FIGS. 4A and 4B, which are a simplified schematic illustration of a solar thermal system, constructed and operative in accordance with still another embodiment of the present invention. As seen in FIG. 4A, a solar thermal system 400 comprises a solar system 402 and a thermal energy system 404.

The solar system 402 communicates with thermal energy system 404. Thermal energy system 404 may receive thermal energy from any number of solar systems 402. For example, several hundred solar systems 402 may supply thermal energy to a single thermal energy system 404 or a plurality of thermal energy systems 404, as will be further described in reference to FIG. 4B hereinbelow.

In the embodiment shown in FIG. 4A, the solar thermal system 400 comprises a closed loop cycle, though it is appreciated that an open loop cycle may be utilized. Additionally, in the embodiment shown in FIG. 4A the solar system 402 is similar to solar system 302. In the solar system 402 the heated working fluid exits the receiver 120 and flows to a heat exchanger 410 of thermal energy system 404.

The heat exchanger 410 is operative to transfer thermal energy in the form of heat to a thermal energy consuming system 440 via a vapor generation cycle 420.

A vapor generation cycle fluid enters heat exchanger 410 from the vapor generation cycle 420 and is heated therein. The heated vapor generation cycle fluid may comprise any suitable fluid, such as water or an organic fluid, for example.

The heated vapor exits the heat exchanger 410 and flows on to thermal energy consuming system 440 via a heat exchanger 450 for utilizing thermal energy of the vapor produced by vapor generation cycle 420. The vapor generation cycle fluid heats a thermal energy consuming system fluid within heat exchanger 450. A pump 452 may be provided to ensure continues flow of the thermal energy consuming system fluid between thermal energy consuming system 440 and heat exchanger 450.

Thermal energy consuming system 440 is designated to provide thermal energy for any thermal energy consuming system, as described hereinabove with reference to thermal energy system 104 of FIGS. 1A and 1B.

Additional heat exchangers (not shown) may be provided to transfer the thermal energy from the solar system 402 on to other thermal systems.

The vapor, generally at near saturation point, exits the heat exchanger 450 and flows on to a condenser 480 wherein the vapor undergoes condensation to a liquid. Alternatively, condenser 480 may be obviated, typically wherein thermal consumption system 440 does not require superheated vapor and therefore heat exchanger 450 may serve as a condenser. An example of such a system wherein the heat exchanger 450 may serve as a condenser is an absorption cooling system or any saturated vapor consuming system.

The liquid exiting the condenser 480 or the heat exchanger 450, wherein condenser 480 is obviated, is introduced into heat exchanger 410 via a pump 482 thereby allowing the liquid of vapor generation cycle 420 to flow continuously.

In a non-limiting example the vapor generation cycle fluid is water. The temperature of the water entering heat exchanger 410 is approximately 80° C. and the pressure is approximately 60 bar. Superheated steam exits the heat exchanger 410 typically at an elevated temperature of approximately 370° C. and the pressure is approximately 60 bar. The steam, generally at near saturation point, exits the heat exchanger 450 and flows on to condenser 480 wherein the steam undergoes condensation to water. The temperature of the steam exiting heat exchanger 450 is approximately 50° C. and the pressure is approximately 0.1 bar. The water exits the condenser 480 substantiality at the temperature and pressure of the steam entering the condenser 480. The water flows from condenser 480 into pump 482 and exits the pump and flows to heat exchanger 410 at approximately 80° C. and a pressure of approximately 60 bar. The vapor heats the thermal energy consuming system fluid, such as oil, within heat exchanger 450 to a temperature of approximately 350° C. and a pressure of approximately 40 bar. The oil exiting thermal consumption system 440 may be reintroduced into heat exchanger 450 at a temperature of approximately 250° C. and the pressure is approximately 30 bar.

As seen in FIG. 4B, a solar thermal system 490 may comprise a plurality of solar systems 402. Although only two solar systems are illustrated, it will be appreciated that any number of solar systems may be provided, typically from ten to several hundred. Each of the plurality of solar systems 402 is in thermal communication with the thermal energy system 404 via a first main duct 492, provided to transfer the working fluid from each of the plurality of solar systems 402 to thermal energy system 404. A second main duct 494 is provided to transfer the working fluid from thermal energy system 404 to each of the plurality of solar systems 402.

Components of the solar thermal systems 400 and 490, such as the solar receiver 120 and pump 430, may be connected therebetween by a plurality of any suitable conduits.

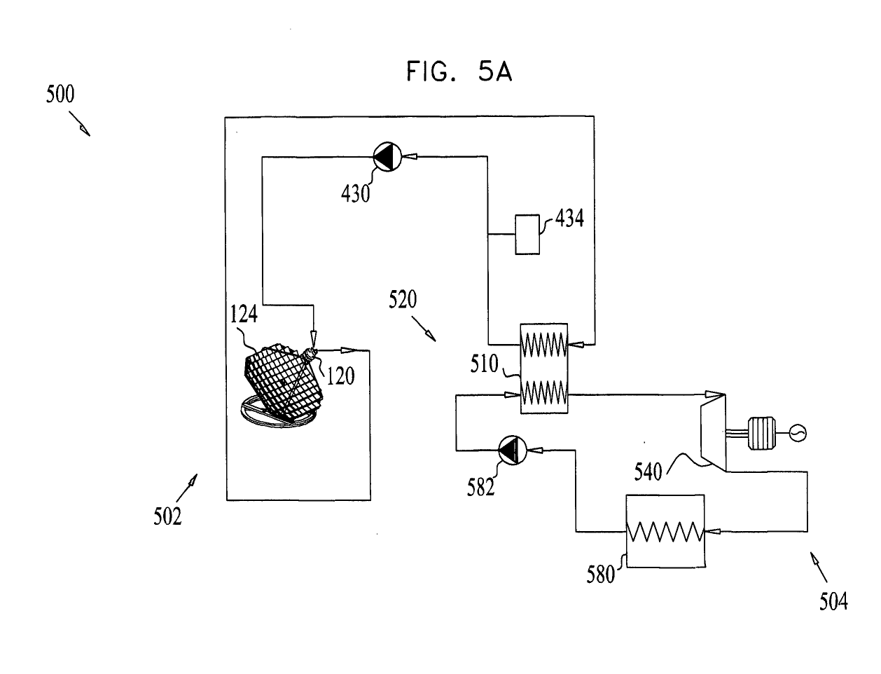

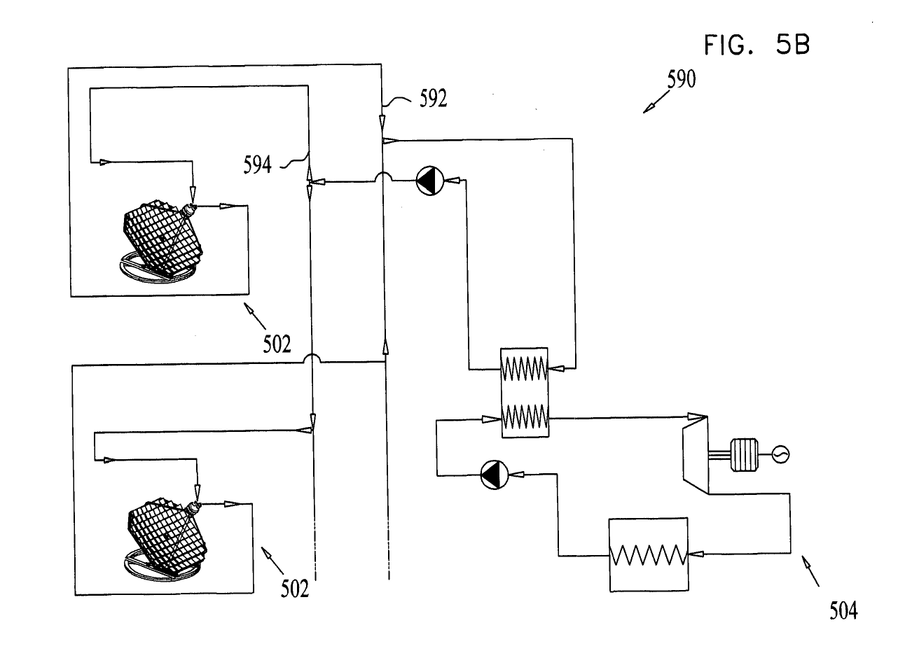

Reference is now made to FIGS. 5A and 5B, which are a simplified schematic illustration of a solar thermal system, constructed and operative in accordance with a further embodiment of the present invention. As seen in FIG. 5A, a solar thermal system 500 comprises a solar system 502 and a thermal energy system 504.

The solar system 502 communicates with thermal energy system 504. Thermal energy system 504 may receive thermal energy from any number of solar systems 502. For example, several hundred solar systems 502 may supply thermal energy to a single thermal energy system 504 or a plurality of thermal energy systems 504, as will be further described in reference to FIG. 5B hereinbelow.

In the embodiment shown in FIG. 5A, the solar thermal system 500 comprises a closed loop cycle, though it is appreciated that an open loop cycle may be utilized. Additionally, in the embodiment shown in FIG. 5A the solar system 502 is similar to solar system 402. In the solar system 502 the heated working fluid exits the receiver 120 and flows to a heat exchanger 510 of thermal energy system 504.

The heat exchanger 510 is operative to transfer thermal energy in the form of heat to a thermal energy consuming system configured as a vapor turbine 540 via a vapor generation cycle 520.

A vapor generation cycle fluid enters heat exchanger 510 from the vapor generation cycle 520 and is heated therein. The heated vapor exits the heat exchanger 510 and flows on to vapor turbine 540 for generation of electrical energy therefrom.

The vapor exits the turbine 540 and flows on to a condenser 580 wherein the vapor undergoes condensation to a liquid. The liquid exiting the condenser 580 is introduced into heat exchanger 510 via a pump 582 thereby allowing the liquid of vapor generation cycle 520 to flow continuously.

In a non-limiting example the heat exchanger is water. The temperature of the water entering heat exchanger 510 is approximately 80° C. and the pressure is approximately 60 bar. Superheated steam exits the heat exchanger 510 typically at an elevated temperature of approximately 370° C. and the pressure is approximately 60 bar. The steam exits the turbine at a temperature of approximately 50° C. and a pressure of approximately 0.1 bar on to condenser 580 wherein the steam undergoes condensation to water. The water exits the condenser 580 substantiality at the temperature and pressure of the steam entering the condenser 580. The water flows from condenser 580 into pump 582 and exits the pump and flows to heat exchanger 410 at a temperature of approximately 80° C. and a pressure of approximately 60 bar.

As seen in FIG. 5B, a solar thermal system 590 may comprise a plurality of solar systems 502. Although only two solar systems are illustrated, it will be appreciated that any number of solar systems may be provided, typically from ten to several hundred. Each of the plurality of solar systems 502 is in thermal communication with the thermal energy system 504 via a first main duct 592, provided to transfer the working fluid from each of the plurality of solar systems 502 to thermal energy system 504. A second main duct 594 is provided to transfer the working fluid from thermal energy system 504 to each of the plurality of solar systems 502.

Components of the solar thermal systems 500 and 590 may be connected therebetween by a plurality of any suitable conduits.

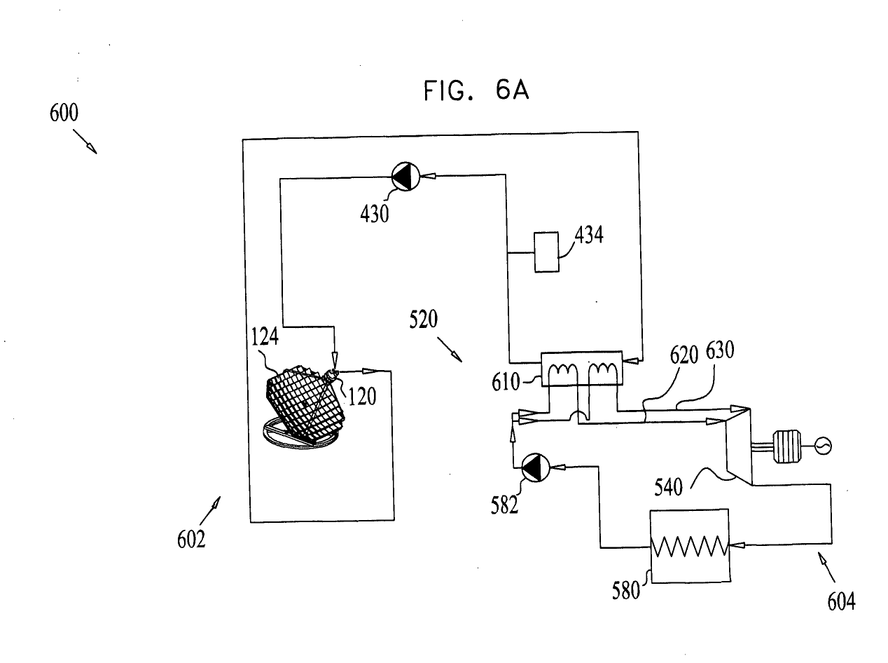

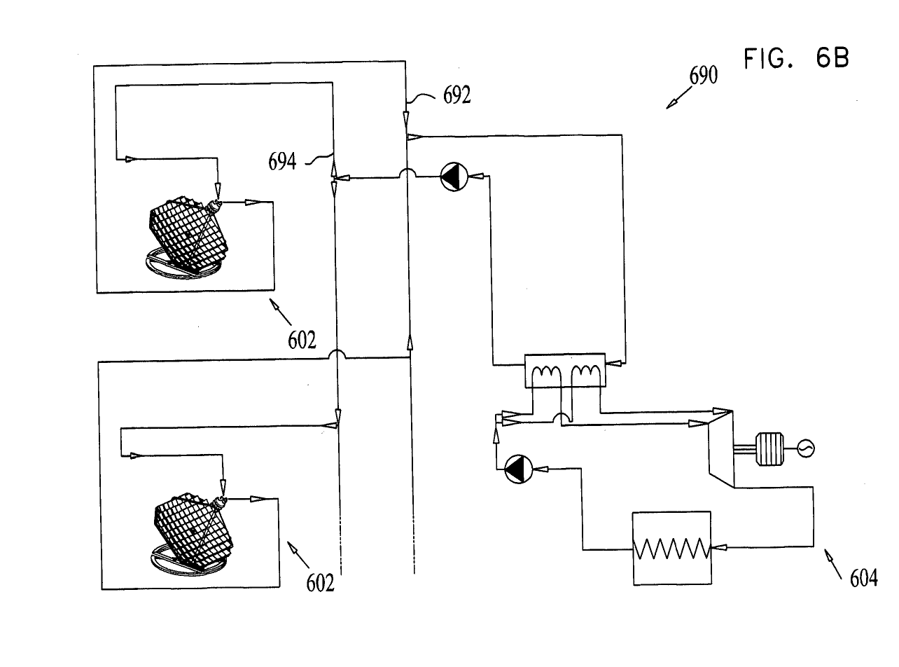

Reference is now made to FIGS. 6A and 6B, which are a simplified schematic illustration of a solar thermal system, constructed and operative in accordance with yet a further embodiment of the present invention. As seen in FIG. 6A, a solar thermal system 600 comprises a solar system 602 and a thermal energy system 604.

The solar system 602 communicates with thermal energy system 604. Thermal energy system 604 may receive thermal energy from any number of solar systems 602. For example, several hundred solar systems 602 may supply thermal energy to a single thermal energy system 604 or a plurality of thermal energy systems 604, as will be further described in reference to FIG. 6B hereinbelow.

In the embodiment shown in FIG. 6A, the solar thermal system 600 comprises a closed loop cycle, though it is appreciated that an open loop cycle may be utilized. Additionally, in the embodiment shown in FIG. 6A the solar system 602 and the thermal energy system 604 are similar to respective solar system 502 and thermal energy system 504 of FIG. 5A. In the thermal energy system 604 a heat exchanger 610 is shown to introduce vapor flowing therefrom to vapor turbine 540 via a plurality of inlets, such as a first inlet 620 and a second inlet 630. Each of the plurality of inlets allows vapor flowing therein to enter the vapor turbine 540 at a different temperature and pressure.

As seen in FIG. 6B, a solar thermal system 690 may comprise a plurality of solar systems 602. Although only two solar systems are illustrated, it will be appreciated that any number of solar systems may be provided, typically from ten to several hundred. Each of the plurality of solar systems 602 is in thermal communication with the thermal energy system 604 via a first main duct 692, provided to transfer the working fluid from each of the plurality of solar systems 602 to thermal energy system 604. A second main duct 694 is provided to transfer the working fluid from thermal energy system 604 to each of the plurality of solar systems 602.

Components of the solar thermal systems 600 and 690 may be connected therebetween by a plurality of any suitable conduits.

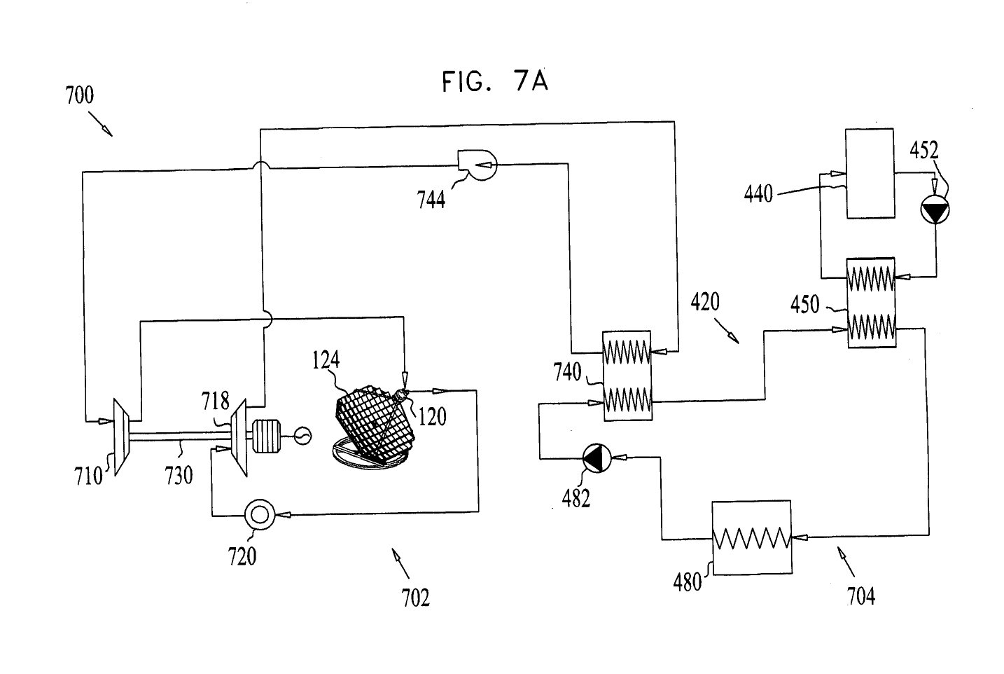

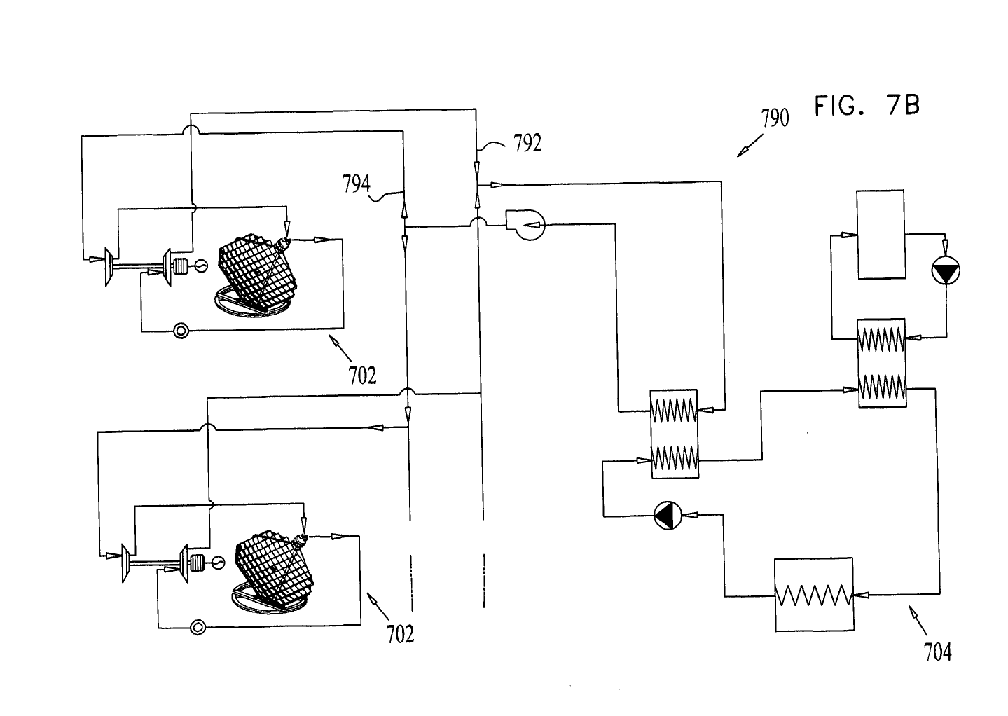

Reference is now made to FIGS. 7A and 7B, which are each a simplified schematic illustration of a solar thermal system, constructed and operative in accordance with still a further embodiment of the present invention. As seen in FIG. 7A, a solar thermal system 700 comprises a solar system 702 and a thermal energy system 704.

The solar system 702 communicates with thermal energy system 704. Thermal energy system 704 may receive thermal energy from any number of solar systems 702. For example, several hundred solar systems 702 may supply thermal energy to a single thermal energy system 704 or a plurality of thermal energy systems 704, as will be further described in reference to FIG. 7B hereinbelow.

In the embodiment shown in FIG. 7A, the solar thermal system 700 comprises a closed loop cycle, though it is appreciated that an open loop cycle may be utilized.

A compressor 710 is provided for allowing incoming working fluid to flow therein. Compressed working fluid flows out of compressor 710 at an elevated pressure and flows to receiver 120. Working fluid exiting the solar receiver 120 flows into a turbine, such as a gas turbine 718 which expands the working fluid for producing electrical energy therefrom. The compressed working fluid exiting the receiver 120 may be further heated by a combustor 720 prior to entering the gas turbine 718. Combustor 720 is provided so as to ensure that the working fluid reaches the gas turbine 718 at a desired temperature, in a non-limiting example, in the range of approximately 800° C.-1100° C., at periods of time wherein incoming solar radiation may be insufficient, typically during early morning, evening and nighttime.

The combustor 720 may be installed in series, between the receiver 120 and gas turbine 718, as seen in FIG. 7A, or may be installed parallelly to the fluid flow through the receiver 120 (not shown).

It is appreciated that in the embodiment of the present invention shown in FIG. 7A the compressor 710 is coupled to gas turbine 718, via a coupling shaft 730 though in alternative embodiments the coupling shaft 730 may be obviated.

The expanded working fluid exits the gas turbine 718 typically at a lowered temperature. The expanded working fluid enters a heat exchanger 740 of thermal energy system 704. A blower 744 may be provided to ensure the working fluid flows continuously between heat exchanger 740 and compressor 710.

Heat exchanger 740 transfers heat to thermal energy system 704. Thermal energy system 704 is similar to thermal energy system 404 of FIG. 4A.

In a non-limiting example, the working fluid is carbon dioxide which enters the compressor 710 at a temperature of approximately 50° C. and a pressure of approximately 5 bar and exits therefrom at a temperature of approximately 250° C. and at a pressure of 20 bar. The temperature of the carbon dioxide exiting receiver 120 is approximately 1000° C. and the pressure is approximately 20 bar. The temperature of the carbon dioxide exiting gas turbine 718 is approximately 650° C. and the pressure is approximately 5.5 bar.

As seen in FIG. 7B, a solar thermal system 790 may comprise a plurality of solar systems 702. Although only two solar systems are illustrated, it will be appreciated that any number of solar systems may be provided, typically from ten to several hundred. Each of the plurality of solar systems 702 is in thermal communication with the thermal energy system 704 via a first main duct 792, provided to transfer the working fluid from each of the plurality of solar systems 702 to thermal energy system 704. A second main duct 794 is provided to transfer the working fluid from thermal energy system 704 to each of the plurality of solar systems 702.

Components of the solar thermal systems 700 and 790 may be connected therebetween by a plurality of any suitable conduits.

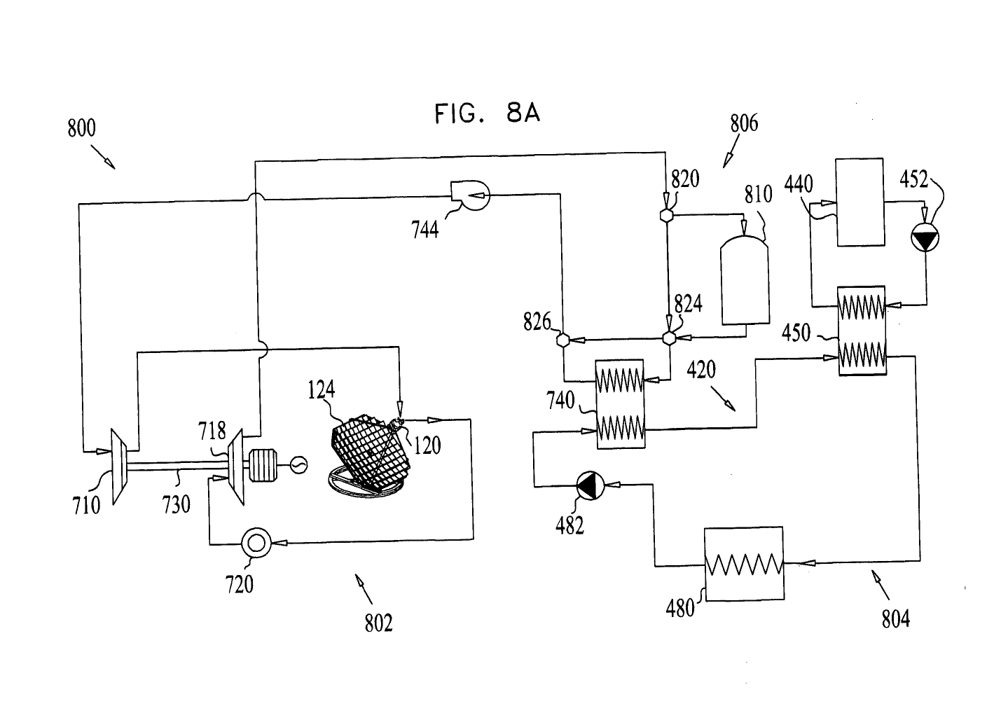

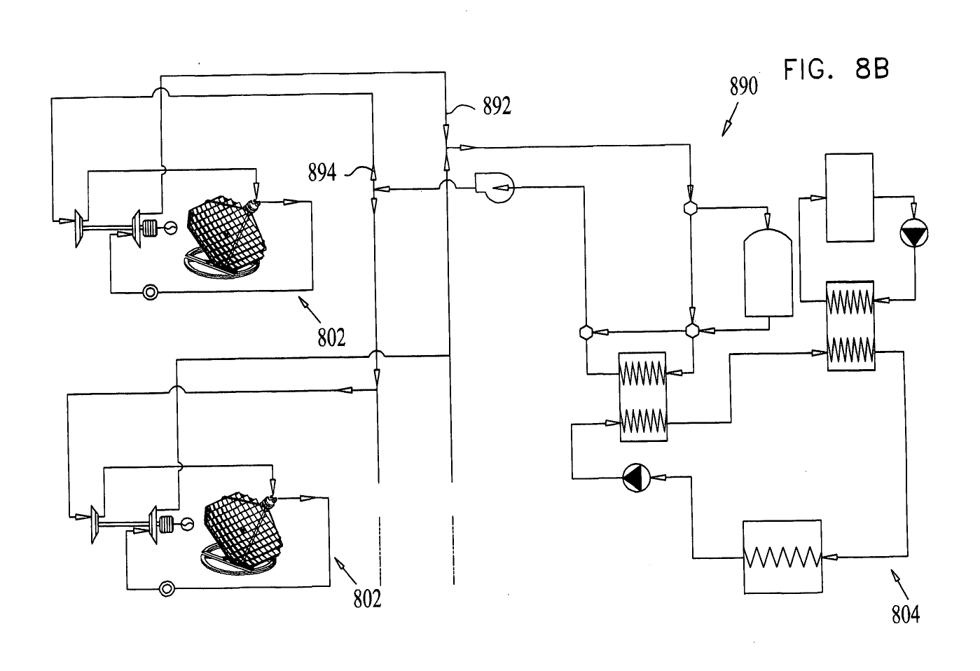

Reference is now made to FIGS. 8A and 8B, which are each a simplified schematic illustration of a solar thermal system, constructed and operative in accordance with another embodiment of the present invention. As seen in FIG. 8A, a solar thermal system 800 comprises a solar system 802 and a thermal energy system 804.

The solar system 802 communicates with thermal energy system 804. Thermal energy system 804 may receive thermal energy from any number of solar systems 802. For example, several hundred solar systems 802 may supply thermal energy to a single thermal energy system 804 or a plurality of thermal energy systems 804, as will be further described in reference to FIG. 8B hereinbelow.

In the embodiment shown in FIG. 8A, the solar thermal system 800 comprises a closed loop cycle, though it is appreciated that an open loop cycle may be utilized. Solar system 802 and thermal energy system 804 are similar to respective solar system 702 and thermal energy system 704 of FIG. 7A.

A thermal storage system 806 may be provided to store heat from solar system 802. The thermal storage system 806 comprises a thermal storage assembly 810 operative to store the heat therein by any suitable means. For example, the thermal storage assembly 810 may comprise a latent heat storage material such as molten salt, organic heat transfer fluid, steam or a sensible heat storage material such as carbon dioxide. The thermal storage assembly 810 may additionally comprise solid high heat capacity materials, or phase change materials. A single storage assembly may have a combination of these materials. For example, solid high heat capacity materials together with latent heat materials or phase change materials together with sensible heat materials. Some storage assemblies may include a hot tank and a cold tank (not shown), used, for example, to maintain a constant temperature in the hot tank. It is noted that thermal storage assembly 810 may comprise any suitable means for providing thermal storage.

A plurality of control valve assemblies 820, 824 and 826 may be provided so as to allow various flow path configurations of the working fluid. An example of various flow path configurations via control valve assemblies 820, 824 and 826 is as follows: all the working fluid from gas turbine 718 is directed by control valve assembly 820 to flow directly to thermal storage assembly 810 so as to be stored therein and thereafter be introduced into the thermal energy system 804 via control valve assembly 824; all the working fluid from gas turbine 718 is directed by control valve assemblies 820 and 824 to bypass the thermal storage assembly 810 and flow directly to the thermal energy system 804; a portion of the working fluid exiting gas turbine 718 is directed by the control valve assemblies 820 and 824 to flow directly to the thermal energy system 804, and a portion is directed by the control valve assembly 820 to flow to storage assembly 810; and all the working fluid exiting gas turbine 718 is directed by the control valve assembly 820 to flow to storage assembly 810 so as to be stored therein and to be reintroduced thereafter into gas turbine 718 via control valve assemblies 824 and 826.

It is noted that any one of control valve assemblies 820, 824 and 826 may be omitted. Furthermore, additional control valve assemblies may be introduced within the thermal storage system 806.

It is further noted that thermal storage system 806 may be situated in any suitable location within the solar thermal system 800.

As seen in FIG. 8B, a solar thermal system 890 may comprise a plurality of solar systems 802. Although only two solar systems are illustrated, it will be appreciated that any number of solar systems may be provided, typically from ten to several hundred. Each of the plurality of solar systems 802 is in thermal communication with the thermal energy system 804 via a first main duct 892, provided to transfer the working fluid from each of the plurality of solar systems 802 to thermal energy system 804. A second main duct 894 is provided to transfer the working fluid from thermal energy system 804 to each of the plurality of solar systems 802.

Components of the solar thermal systems 800 and 890 may be connected therebetween by a plurality of any suitable conduits.

It is appreciated that thermal storage system 806 may be provided in the solar thermal systems of FIGS. 1A-7B for storage of thermal energy therein.

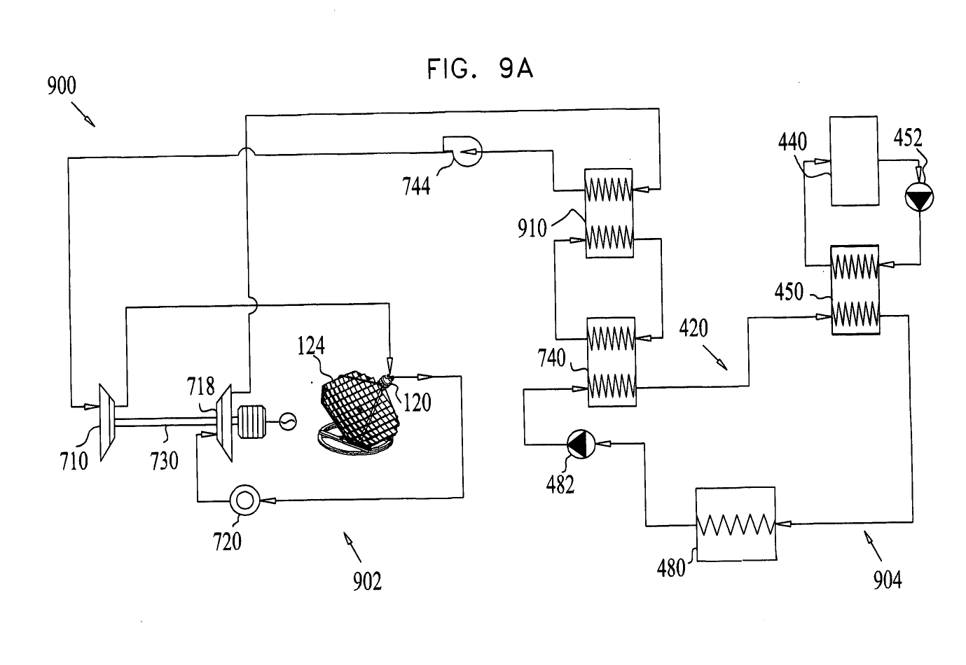

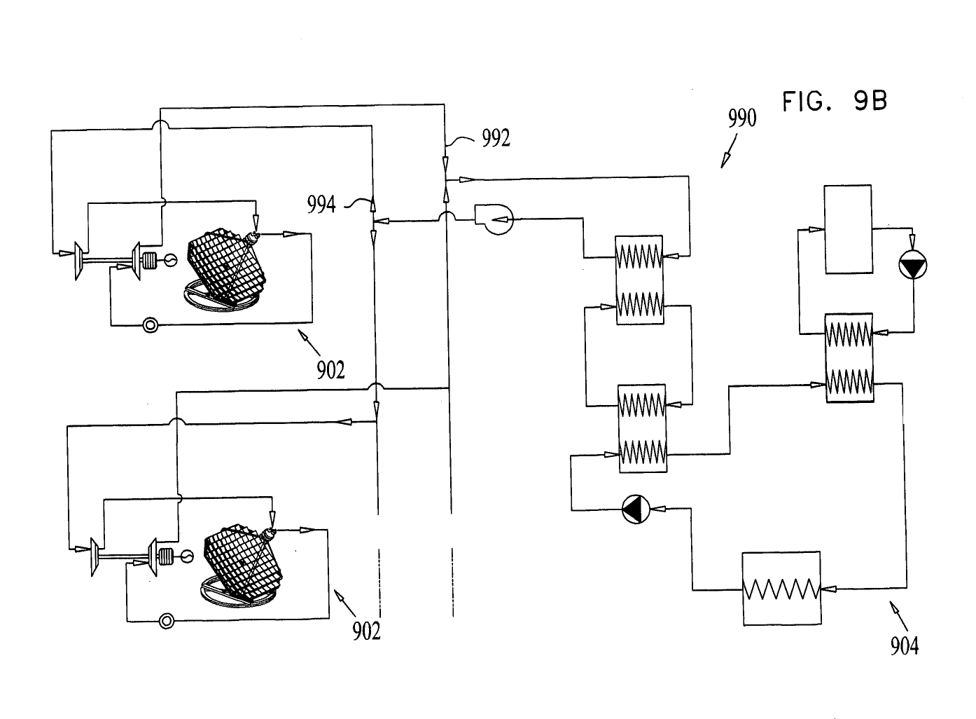

Reference is now made to FIGS. 9A and 9B, which are each a simplified schematic illustration of a solar thermal system, constructed and operative in accordance with yet another embodiment of the present invention. As seen in FIG. 9A, a solar thermal system 900 comprises a solar system 902 and a thermal energy system 904.

The solar system 902 communicates with thermal energy system 904. Thermal energy system 904 may receive thermal energy from any number of solar systems 902. For example, several hundred solar systems 902 may supply thermal energy to a single thermal energy system 904 or a plurality of thermal energy systems 904, as will be further described in reference to FIG. 9B hereinbelow.

In the embodiment shown in FIG. 9A, the solar thermal system 900 comprises a closed loop cycle, though it is appreciated that an open loop cycle may be utilized. Solar system 902 and thermal energy system 904 are similar to respective solar system 702 and thermal energy system 704 of FIG. 7A. In solar system 902 an additional heat exchanger 910 is provided intermediate solar system 902 and thermal energy system 904. Heat exchanger 910 is provided to heat a heat transfer fluid such as a gas, typically air, by the working fluid flowing therein from solar system 902. The heated heat transfer fluid enters heat exchanger 740 of thermal energy system 904 so as to heat thereby the thermal energy system 904.

As seen in FIG. 9B, a solar thermal system 990 may comprise a plurality of solar systems 902. Although only two solar systems are illustrated, it will be appreciated that any number of solar systems may be provided, typically from ten to several hundred. Each of the plurality of solar systems 902 is in thermal communication with the thermal energy system 904 via a first main duct 992, provided to transfer the working fluid from each of the plurality of solar systems 902 to thermal energy system 904. A second main duct 994 is provided to transfer the working fluid from thermal energy system 904 to each of the plurality of solar systems 902.

Components of the solar thermal systems 900 and 990 may be connected therebetween by a plurality of any suitable conduits.

It is appreciated that thermal storage system 806 of FIGS. 8A and 8B may be provided in the solar thermal system of FIGS. 9A and 9B for storage of thermal energy therein.

Main ducts and/or the conduits of FIGS. 1A-9B may be formed at least partially of pipes designed to transfer the working fluids. Such pipes are generally formed with thermal insulation so as to prevent heat losses of the working fluids as the working fluids flow along the main duct and/or the conduits. Such a pipe may be a pipe-in-pipe pipeline commercially available by ITP InTerPipe, Inc. of 16360 Park Ten Place, Suite 327 Houston, Tex., USA, for example.

It is noted that the solar thermal system of FIGS. 1A-9B may comprise a plurality of thermal energy systems in fluid communication with a single or a plurality of the solar systems of FIGS. 1A-9B.

It is further noted that blowers and/or pumps may be added to the solar systems and/or the thermal energy systems of FIGS. 1A-9B to ensure that the working fluid flows continuously. Typically, wherein the working fluid is a gas, such as air, a blower may be provided, and wherein the working fluid is a liquid, such as water, a pump may be provided to ensure continuous flow of the working fluid.

Use of a plurality of solar systems, as seen in FIGS. 1B, 2B, 3B, 4B, 5B, 6B, 7B, 8B and 9B, provides for an increased flow rate of the working fluid flowing therefrom to a thermal energy consuming system.

Thus a solar thermal system which is to provide a desired amount of thermal energy to a thermal energy consuming system may be structured to comprise a number of solar systems in accordance with the desired thermal energy amount. Thus a solar thermal system providing thermal energy to a thermal energy consuming system that requires a relatively great amount of thermal energy will comprise a relatively large number of solar systems while a solar thermal system providing thermal energy to a thermal energy consuming system that requires relatively less thermal energy will comprise a relatively smaller number of solar systems.

Additionally, provision of dish 124 along with the solar receiver 120 for concentrating the solar radiation in the plurality of solar systems allows for selecting with relative ease the number of solar systems needed to provide a desired amount of thermal energy consumed by the thermal energy consuming systems. This is due to the relatively few components needed for sun-tracking and concentrating the solar radiation, i.e., mainly the dish 124 and solar receiver 120, which provide for enhanced modularity of the solar systems.

Specifically, selection of the number of solar cycles in accordance with the desired amount of thermal energy provided to a thermal energy consuming system enables structuring a solar thermal system in accordance with the geographical conditions of a specific location of the solar thermal system. For example, in areas wherein the annual direct solar radiation emitted from the sun is of relatively low intensity, a relatively high number of solar systems may be employed, compared to an area with more annual direct solar radiation, so as to compensate for the relatively low solar intensity. In contrast, in an area wherein the annual solar radiation emitted from the sun is of relatively high intensity, the number of solar systems selected may be lower than in other areas.

Additionally, it is known in the art that each turbine is designed to perform with maximal efficiency at a predetermined flow rate of incoming heated working fluid. Thus selection of the number of the solar systems enables structuring a solar thermal system in accordance with a desired predetermined flow rate suitable for a specific selected turbine of the thermal energy systems of FIGS. 5A-6B, thereby ensuring that the turbine thereof will perform at maximal efficiency. In a non-limiting example, wherein a single solar system is employed, the electrical output of the solar thermal systems of FIGS. 5A-6B with a dish 124 of a surface area of about 480 m² is approximately 90-120 Kilowatt. Whereas, wherein a hundred solar systems are employed, the electrical output of the solar thermal systems of FIGS. 5A-6B is approximately 25 Megawatt.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1-41. (canceled)

42. A solar thermal system comprising:
at least one solar system including:
a solar system working fluid flowing therethrough; and
a solar receiver for heating said solar system working fluid by solar radiation admitted into said solar receiver; and
at least one thermal energy system in fluid communication with said at least one solar system,
said thermal energy system for utilizing thermal energy from heated said solar system working fluid.

43. A solar thermal system according to claim 42 and wherein said solar radiation is concentrated by a dish configured to concentrate said solar radiation prior to being admitted into said solar receiver.

44. A solar thermal system according to claim 42 wherein said solar system working fluid is selected from the group consisting of air, water, helium, molten salt, an organic fluid, oil, and carbon dioxide.

45. A solar thermal system according to claim 42 wherein said thermal energy is used for vaporization, pasteurization, drying, drying polymer containing products, providing vapor to vapor consuming systems, direct heating of a solid desiccant system or absorption cooling.

46. A solar thermal system according to claim 42 wherein said thermal energy system comprises a vapor turbine for generating electrical energy.

47. A solar thermal system according to claim 42 wherein said thermal energy is used for boosting a vapor turbine.

48. A solar thermal system according to claim 42 wherein said thermal energy is used for boosting a steam turbine comprised in a combined cycle gas fired system.

49. A solar thermal system according to claim 42 wherein said solar system is an open loop system or a closed loop system.

50. A solar thermal system according to claim 42 wherein said thermal energy system is an open loop system or a closed loop system.

51. A solar thermal system according to claim 42 being configured to introduce said solar system working fluid into at least one heat exchanger.

52. A solar thermal system according to claim 42 wherein said thermal energy system comprises a vapor generation cycle.

53. A solar thermal system according to claim 42 wherein said thermal energy system comprises a vapor turbine with a plurality of inlets for flow of vapor therein.

54. A solar thermal system according to claim 42 wherein said solar system comprises a turbine for generation of electricity.

55. A solar thermal system according to claim 42 wherein said solar system comprises a compressor configured to compress said solar system working fluid prior to entering said solar receiver.

56. A solar thermal system according to claim 42 wherein a combustor is provided intermediate said solar receiver and a gas turbine.

57. A solar thermal system according to claim 42 and comprising a thermal storage assembly configured to selectively store at least some of heated said solar system working fluid.

58. A solar thermal system according to claim 42 wherein said thermal energy system is in fluid communication with said at least one solar system via a heat exchanger

59. A solar thermal system according to claim 58 wherein a heat transfer fluid is heated in said heat exchanger by said solar system working fluid, heated said heat transfer fluid provided to heat a vapor generation cycle fluid of a vapor generation cycle.

60. A solar thermal system according to claim 42 comprising a plurality of solar systems.

61. A method for utilizing thermal energy comprising:
concentrating solar radiation by a dish;
heating a working fluid within a solar receiver by concentrated said solar radiation impinging thereon; and
providing said heated working fluid to at least one thermal energy system for utilizing thermal energy of heated said working fluid.
